(19) United States
(12) Patent Application Publication
(10) Pub. No.: US 2015/0344037 A1
(43) Pub. Date: Dec. 3, 2015

(54) METHOD AND DEVICE FOR PREDICTIVE DETERMINATION OF A PARAMETER VALUE OF A SURFACE ON WHICH A VEHICLE CAN DRIVE

(71) Applicant: AUDI AG, Ingolstadt (DE)

(72) Inventors: ANDREAS SIEGEL, Ingolstadt (DE); MICHAEL REICHEL, Ingolstadt (DE)

(73) Assignee: AUDI AG, Ingolstadt (DE)

(21) Appl. No.: 14/653,626

(22) PCT Filed: Dec. 16, 2013
(86) PCT No.: PCT/EP2013/003784

§ 371 Date: Jun. 18, 2015

(30) Foreign Application Priority Data
Dec. 19, 2012 (DE) 10 2012 024 874.1

(51) Int. Cl. B60W 40/068; G01N 19/02; G01J 5/02; B60W 40/06

(52) U.S. Cl. CPC B60W 40/068; B60W 40/06; G01N 19/02; G01J 5/02

(57) ABSTRACT

A method for predictive determination of a parameter value of a surface on which a vehicle can drive, includes the steps of detecting a total surface that is provided for the vehicle to drive on, determining a partial region within the total surface, on which the vehicle can actually drive, determining the parameter value only for the partial region, and providing the parameter value to at least one driver assistance system of the vehicle. A control device for performing the method is also disclosed.

The invention relates to a method for predictive determination of a parameter value according to the preamble of claim 1. Furthermore, the invention relates to a control device for carrying out the method.

In the field of driver assistance and safety systems for vehicles, it is desirable to be able to record and evaluate most comprehensive detailed information about the environment in order to optimize control of a vehicle with respect to the environment. Important is information about the road conditions, in particular the surface and its coefficient of friction, for example, in order to prevent, for example, a driving assistance system and safety system from changing a driving state too abruptly or too late, for example by initiating excessive braking, or not even warning of a dangerous situation. If the coefficient of friction of the road surface and a change in the coefficient of friction in the road surface is known, for example an expected braking distance can be estimated and braking can be initiated early enough and with the right magnitude. The coefficient of friction is therefore an important factor via which an intervention by a driving assistance and safety system in a driving dynamics of the vehicle can be controlled, when the coefficient of friction can be estimated or determined with sufficient accuracy.

Although the opportunity already exists today to obtain information on the coefficient of friction of vehicles ahead, it would still be desirable to independently determine the coefficient of friction of a road surface ahead by the own vehicle as accurately as possible. Information transmitted by preceding vehicles, in particular coefficients of friction, has a drawback that this information may no longer be timely of: the situation and can change abruptly, for example due to rain, oil spills or any type of obstacles. It should therefore be possible to determine the coefficient of friction or at least an estimate thereof independently even when the vehicle is rolling on the road surface without steering, braking or acceleration activity, i.e. independently of a driving state of the vehicle, in particular independently of a frictional force acting on the vehicle.

The patent DE 10 2004 023 323 B4 discloses a device and a method for detecting a condition of a road surface for a vehicle by using a spectrally resolving radiation receiver, such as a night vision camera with heat radiation detection, (pyrometer), wherein the road surface is characterized by a coefficient of friction, which is determined from of a temperature profile in the detected thermal image, and wherein the detected portion of the road surface can be defined by imaging magnification means arranged upstream of the radiation receiver, in particular by a predetermined range defined by an absolute length, for example 50 to 100 meters ahead of the vehicle. The condition of the road surface can be detected without onboard radiation emitters, i.e. solely through evaluation of (light) radiation that is anyway incident on the vehicle. Furthermore, the imaging magnification means may be further developed as a means for tracking a road course, so that the detected area can also be defined with respect to curves or sloping road sections.

It is an object of the invention to provide a method or a device that can be used to characterize the properties of a road surface by evaluating measurement data detected by a vehicle, and to provide the information obtained by the evaluation in most appropriate possible manner for the vehicle.

This object is attained with a method having the features of claim 1 and with a control device having the features of the other independent claim. Advantageous embodiments with beneficial developments of the invention are recited in the dependent claims.

The invention is based on a method for predictive determination of a parameter value of a surface area on which the vehicle can travel and for providing the parameter value to at least one driver assistance system of the vehicle, by detecting a total surface on which the vehicle can travel, in particular by detecting the radiation emitted by the total surface.

According to the invention, the following steps are hereby performed:

Determining a partial region within the total surface, in which the vehicle can in fact travel, and

Determining the parameter value exclusively for the partial region.

On the one hand, the amount of data that must be evaluated can be reduced by excluding non-navigable areas or partial regions. On the other hand, false analyses can be avoided, in particular because, for example, road sections where a vehicle with a heat-radiating underbody is parked may be excluded. The parameter value, in particular the coefficient of friction, is changed in this section or area; however, the car is unable to use the area, making processing of this information and transmission to a driver assistance system not useful.

In most cases, the surface will be defined having a specific course, i.e. by a road known for example from a road database; however, the described method can be performed equally well on a surface without a definable course, such as a parking lot. The overall surface can be restricted, on the one hand, to a predetermined portion of the surface usable by the vehicle (especially a road course or lane course) and, on the other hand, on a navigable partial region, i.e. an area without any insurmountable obstacles (objects or subjects) for the vehicle. The obstacles may therefore also be movable and need not be stationary. An obstacle may be formed, for example, by an oncoming vehicle or an obstacle moving, for example, transversely to the driving direction.

The invention is also based on the realization that there is no need to determine and evaluate a road course or the absolute position of the vehicle, but that an improved (data) base can already be provided in that an analysis of the (road) surface itself is performed to determine which areas are irrelevant and may be excluded in the further determination of parameter values. This already produces a filtered and error-corrected database in a simple process stage, namely still during the evaluation of the environmental data characterizing the surface or the road. The indicator that can be used for excluding partial regions of the surface thus represent insurmountable obstacles which usually also affect the parameter value, in particular the coefficient of friction, especially due to temperature changes. In other words, the described method can be used for a failsafe analysis based on the relative data without relying on an absolute geographical position or the road course.

Predictive determination hereby refers to a forward-looking determination, wherein not physical quantities, such as a friction between a tire and the road surface, measured by the vehicle itself are determined for the currently traveled section of the road, but a yet-to-be-travelled section of the road is examined, in particular by evaluating the radiation emitted from the section of the road still to be traveled.

According to an advantageous exemplary embodiment, the partial region is determined by identifying an insurmountable obstacle for the vehicle on the total surface. The obstacles can be detected, for example, by comparing captured image areas or pixels with stored standard geometries, for example a rear of a vehicle or the outline of a person, or by examining a captured image in certain coordinate directions for predetermined contours or geometries. Optionally, in addition to or exclusively in conjunction with the comparison with stored standard geometries, a region above the (road) surface can be examined for the presence of contours oriented vertically at an angle relative to the road surface.

The obstacle may be detected, for example, with a surroundings sensing device, such as a radar device, provided on the vehicle, but may also be detected based on a database generated by detecting the total surface.

According to an advantageous exemplary embodiment, the total surface is captured by evaluating radiation incident on the vehicle. The incident radiation may optionally have been emitted by the vehicle itself, i.e. it represents its own reflected radiation, or it may be radiation that is incident on the vehicle without a radiation transmitter, e.g. daylight or artificial light in an illuminated tunnel.

According to an advantageous exemplary embodiment, a coefficient of friction characterizing the friction between a tire of the vehicle and the surface in the partial region is used as the parameter value. The coefficient of friction is an important parameter for controlling the vehicle since it defines the maneuver that can be performed on the surface without departing from a safe driving condition. The coefficient of friction may be determined, for example, from a thermal image captured by a thermal imaging camera. The parameter value may also (optionally additionally) be related to a material of the road surface, for example blacktop, concrete, or cobblestones.

According to an advantageous exemplary embodiment, the total surface is detected by detecting thermal radiation, in particular by means of a surroundings sensing device. Road surface data characterizing the parameter may be extracted from a thermal image obtained from the thermal radiation by analyzing a temperature profile in the thermal image and determining a change of the parameter value of the thermal image, in particular by using the surroundings sensing device or a controller separate therefrom. In other words, the road surface data already include the indication or information as to the manner in which the parameter value changes, in particular depending on the location, and the road surface data may in a variant of the method be correlated with environmental data for the purpose of detecting and evaluating in relation to a specific road course. Therefore, the parameter value itself is not directly detected, but a database is initially created, for which thereafter one or more specific parameters, in particular a coefficient of friction or a surface roughness, can be specified, wherein the data are evaluated with respect to these parameters or this parameter. For example, it can be much more difficult to calculate a coefficient of friction for an unpaved road or a gravel road, than for a uniformly paved road, so that it may be useful to evaluate the road surface with respect to the material of the road, the grain size (size of the pebbles), the temperature and/or any contamination such as leaves, oil films, moisture, etc.

Areas of the surface where a special risk exists can be determined by identifying changes in the value of the coefficient of friction, since the friction usually changes here abruptly, which can cause an unsafe driving condition, especially in curves. Even when a vehicle is controlled by ESP or other vehicle dynamics control systems, a sudden change in the value of the coefficient of friction may cause this system to fail. These systems can be forewarned by predictive determination of the changes in the coefficient of friction and an intervention in the driving dynamics can be controlled accordingly.

According to an advantageous exemplary embodiment, the partial region and the parameter value are evaluated by a control device or a vehicle system coupled to the control device, wherein it is being checked whether a function of the vehicle is to be controlled. The vehicle can then be controlled, in particular also with respect to other data, such as data for a road course and/or an absolute or a relative position of the vehicle, as will be described hereinafter in more detail.

Optionally, in connection with the described method, a road course and the geographical position of the vehicle may be considered. In other words, the parameter values may be provided so as to enable control of the vehicle by a driver assistance system, specifically with regard to the road course and, optionally, the relative position of the vehicle on the road. For this purpose, the method described in more detail below is suitable, which is a further development of the method described above.

A method for providing a parameter value characterizing a road surface in relation to a road course ahead as well as to a geographical position and a driving direction of a vehicle using the road for at least one driver assistance system of the vehicle includes the following steps:

a) retrieving geographical real-time position data for the vehicle position of the vehicle and detecting the driving direction of the vehicle;
b) detecting environmental data in a predetermined environment around the vehicle position with a surroundings sensing unit;
c) evaluating the environmental data for recognizing in the environment road data at least of the used road, and with a control device, associating the vehicle with the road;
d) determining the vehicle position on the road by combining, with the control device, the road data with the position data;
e) determining the road course from the road data with respect to the driving direction;
f) detecting thermal radiation reflected from and/or emitted by the road surface, and generating road surface data;
g) determining, from the road surface data, the parameter value characterizing the road surface, in particular a coefficient of friction;
h) evaluating the road course in conjunction with the parameter value;
i) providing the vehicle position, the road course, and the parameter value, in particular the coefficient of friction;
wherein the steps can be further developed by:

when evaluating the environmental data or road surface data: determining a non-navigable section or partial region of the road, especially from the environmental data, and in particular by detecting obstacles on the road that are insurmountable for the vehicle, in particular by examining a section above the road surface for the presence of contours oriented vertically at an angle to the road surface;

when determining or evaluating the road course: excluding the non-navigable section or partial region from the environmental data and evaluating the remaining navigable section or partial region; and

in step i): providing the road course and the parameter value, in particular with respect to the location on the navigable section or partial region, by combining the road surface data with the remaining not-excluded environmental data.

The environmental data may, for example, be provided by a map database of a navigation system and/or be retrieved in real time for the relevant geographical area. The predeterminable environment may be delimited, for example, by a zone around the vehicle that may be geometrically fixed or may be variably defined.

Geographic real-time position data of the vehicle are preferably retrieved by an onboard GPS system capable of receiving and evaluating GPS signals. Data relating to a driving direction of the vehicle can be generated from the time dependence of the position data received by way of the GPS signals. However, the data can also be determined by an onboard compass device configured to output compass data or driving direction data with respect to a central longitudinal axis of the vehicle.

The environmental data may optionally, at least partially be loaded from a storage unit of the vehicle, in particular in an environment correlating with the driving direction of the vehicle.

The geographical real-time position data may be transferred to an onboard storage unit and correlated with environmental data previously stored in the storage unit or only with the environmental data captured in response to determining the position.

The onboard storage unit may be configured as a buffer memory in which map data and environmental data are cached only, for example when they are currently retrieved via an (Internet) connection; however, the onboard storage unit may also alternatively or additionally be configured as a type of hard disk storage unit, where the environmental data are permanently stored, thus obviating the need for communication with an external independent vehicle map database.

The radiation may be detected with the surroundings sensing device, or with a separate radiation detection unit. The radiation detection unit may, for example, be designed as a thermal imaging camera. Road surface data may be generated in step f) with the control device, or alternatively with a separate evaluation unit which extracts and analyzes a temperature profile of the road surface ahead of the vehicle from a thermal image of the radiation detection unit, in particular a so-called night vision camera, and determines or estimates therefrom a change in the coefficient of friction ahead of the vehicle.

According to a variant of the method, the calculated data may be checked when passing a portion of the road, for which a previously estimated coefficient of friction was determined, because a coefficient of friction can usually be determined in a simpler and more accurate manner when traversing these areas, in particular from the friction values recorded on the tires of the vehicle. A plausibility check with regard to the predictive estimated coefficients of friction may be derived therefrom.

While it may be advantageous, for example in view of the dataset to be evaluated and the required calculation time, to determine only a road course in a nearby environment in the driving direction ahead of the vehicle, the nearby environment may however also be arranged concentric around the vehicle or elliptical around the vehicle, with the longer axis of the ellipse oriented in the driving direction, in order to provide to a driver assistance system also information regarding an environment or surroundings in the rear area of the vehicle, i.e. to the side and behind the vehicle. If the vehicle is stopped, i.e. when the vehicle is not traveling in a particular direction, then the driving direction may be defined by the center longitudinal axis of the vehicle, i.e. the position data may be evaluated even when they don't change over time, because the direction into which the front of the vehicle points is known for a parked vehicle, so that the method according to the invention can be performed with respect to the driving direction.

The road data may optionally be determined or detected, in particular areas may be extracted from the captured image data that correspond to the used lane, in step c) and/or step g), i.e. based on the data provided by the surroundings sensing device and/or by the data provided by the radiation detection unit.

In step g), the surroundings sensing device can detect the height of the obstacles in a vertical direction, i.e. substantially vertically with respect to a road surface, and define therefrom when the obstacle becomes insurmountable for the vehicle. In other words, the road surface or the region directly above the road surface is examined for vertical discontinuities, i.e. contours that extend in a vertical direction.

Preferably, determining in step g) is performed in dependence of the road course. This allows the analysis of the road surface to be focused on those areas that are expected to be passed by the vehicle.

It can be determined in the step h) whether more slippery conditions, i.e. a lower coefficient of friction, can be expected in a particularly windy area of the road. The vehicle can be controlled more predictively and more safely.

Preferably, the road course is evaluated together with the parameter value in step h) by correlating the parameter value with the road course and by evaluating a change of the parameter value and by relating the parameter value to certain sections of the road course, if the parameter value changes in the certain sections of the road course. In this way, for example, a particularly tight curve can be examined and a change of the parameter value in this area may result in a more forward-looking action and/or a clearer warning message by the driver assistance system than if the change were to occur along a straight section of the road. This increases the driving safety. In step i), the vehicle position and the road ahead with the parameter value related thereto, in particular the coefficient of friction, is preferably provided.

Combining the road surface data with the environmental data in step i) can be used to exclude sections of the road in a second step, even when a change of the parameter values is associated with an obstacle on the road, because the obstacle must be bypassed, which usually goes hand in hand with a change in the driving condition of the vehicle, and the coefficient of friction is of particular importance when changing the driving condition.

In summary, it should be mentioned in conjunction with the determination of the road course that, according to a variant of the method, the road course is converted by means of a mathematical camera model into pixel coordinates of a thermal image, which should potentially be evaluated. Before evaluating the surface parameter, those image areas may be excluded that correspond to detected obstacles that are converted by the camera model. Thus, a non-navigable surface that could distort the results is not reproduced in the captured thermal image. The road course may be determined in a three-dimensional manner, i.e. with respect to all three directions in space.

The determined road course may be used, when taking into account the excluded non-navigable sections, for further steps of the process, in particular the steps of:

k) retrieving driving condition data for a driving condition of the vehicle; and
l) operating at least one function of the vehicle depending on the vehicle position, the road course, the parameter value, and in dependence of the driving condition.

These steps may be taken over by a driver assistance system, which may be designed as a subsystem of the vehicle system.

Optionally, the detection in step b) and the evaluation in step c) and/or the determination in step e) and/or the detection in step f) may take place in a nearby environment around the vehicle, in particular in the nearby environment of 1 to 1000 m, preferably 10 to 500 m, particularly preferably 20 to 200 m around the vehicle. Optionally, the nearby environment may be defined in relation to the driving direction and/or in relation to the road course, for example for a serpentine-shaped road course as a rectangle or even a square disposed sideways transversely to the vehicle, or for a highway running substantially in only one direction, elongated and linearly along the highway in the driving direction. This allows a reduction in the amount of data to be processed.

Optionally, the environmental data may be loaded at least partially from a storage unit and/or loaded into the vehicle via a communication interface, particularly online from the Internet. The method can thereby be extended also to road sections that cannot be detected by a camera, a laser scanner, a radar unit or the like, i.e. to road sections that are not visible. The allows for example a first rough detection of the road course and an early warning, for example driving on the crest of hills, in tight curves, deep valleys or when the surroundings-sensing unit operating with a line-of-sight fails.

The online database for loading aerial images may be any database where preferably most current aerial images are stored. Preferably, the control device is configured to connect to several online databases, either simultaneously or sequentially, and to check in which online database the aerial image data for the region of interest with greater timeliness and/or larger or better resolution (i.e. more detailed aerial images, in particular aerial images with a smaller scaling factor, i.e. aerial images taken from a lower altitude) are stored so as to be able retrieve the aerial images with the respective greater resolution or the most current aerial images.

The object is also attained with a control device for predictive determination of a parameter value of a surface navigable by a vehicle and by providing the parameter value to at least one driver assistance system of the vehicle, wherein the control device is configured to evaluate surface data of a total surface that is provided for the vehicle to drive on, and wherein according to the invention the controller is further configured to determine a partial region within the total surface that can actually be navigated by the vehicle, and to determine the parameter value only for the partial region.

The described method and the described control device can be used in conjunction with a safety system that has at least one surroundings-sensing unit and that is configured to determine from the detected environment a course of a road, either autonomously or in conjunction with externally provided (map) data.

The embodiments presented with reference to the method of the invention and their advantages apply mutatis mutandis also to the claimed control device.

The features and feature combinations mentioned above in the description, and the individual features and feature combinations described below in the description of the drawings or illustrated alone in figures can not only be used in the particular stated combination, but also in other combinations or alone, without going beyond the scope of the invention.

Additional advantages, features and details of the invention can be derived from the claims, the following description of preferred embodiments and from the drawings, in which identical or functionally identical elements are provided with identical reference symbols, wherein:

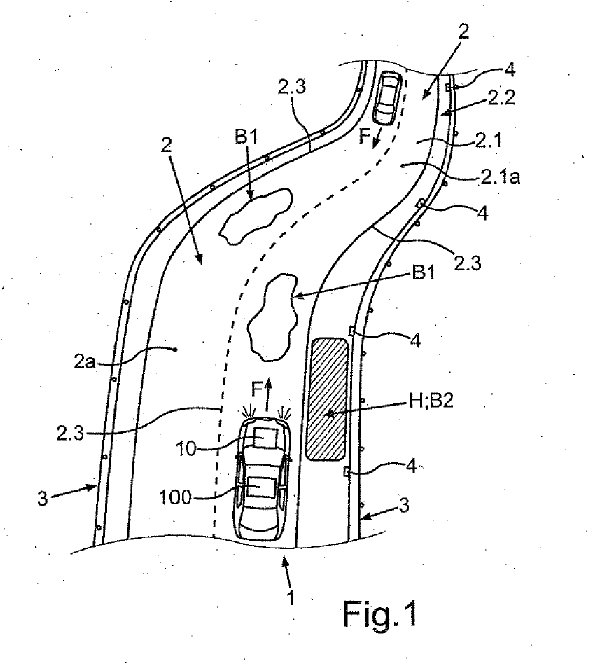

FIG. 1 shows in a perspective top view a schematic diagram of a driving situation of a vehicle on a road, wherein the vehicle is constructed with a vehicle system that includes a control device for controlling the vehicle according to a method according to the invention;

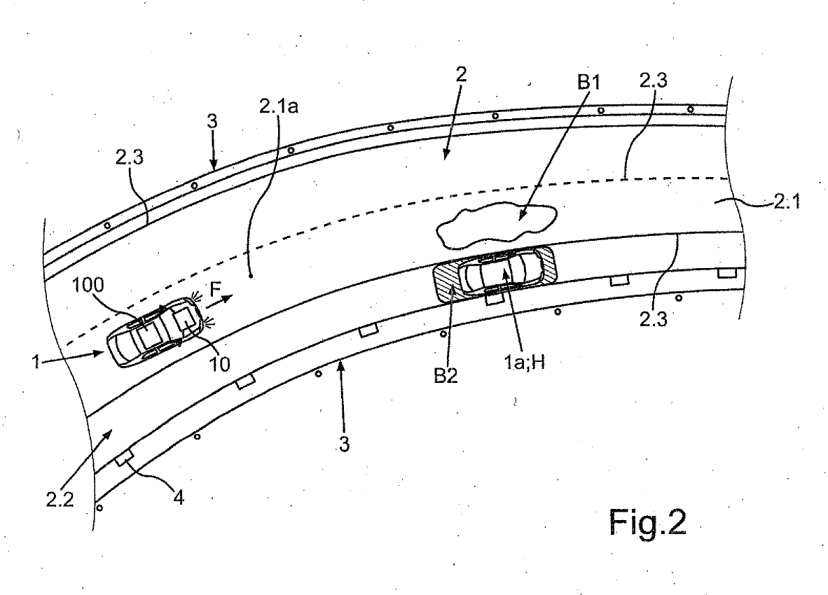

FIG. 2 shows in a perspective top view a schematic diagram of another driving situation of a vehicle on a road, wherein the vehicle is constructed with a vehicle system that includes a control device for controlling the vehicle according to a method according to the invention;

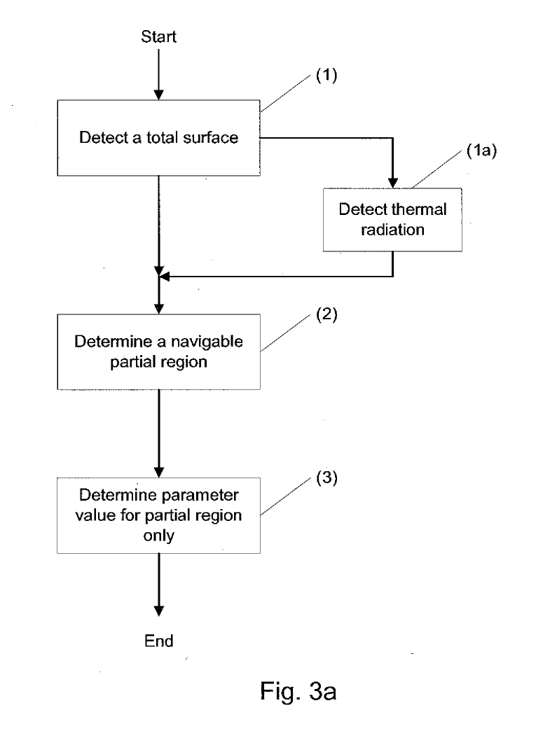

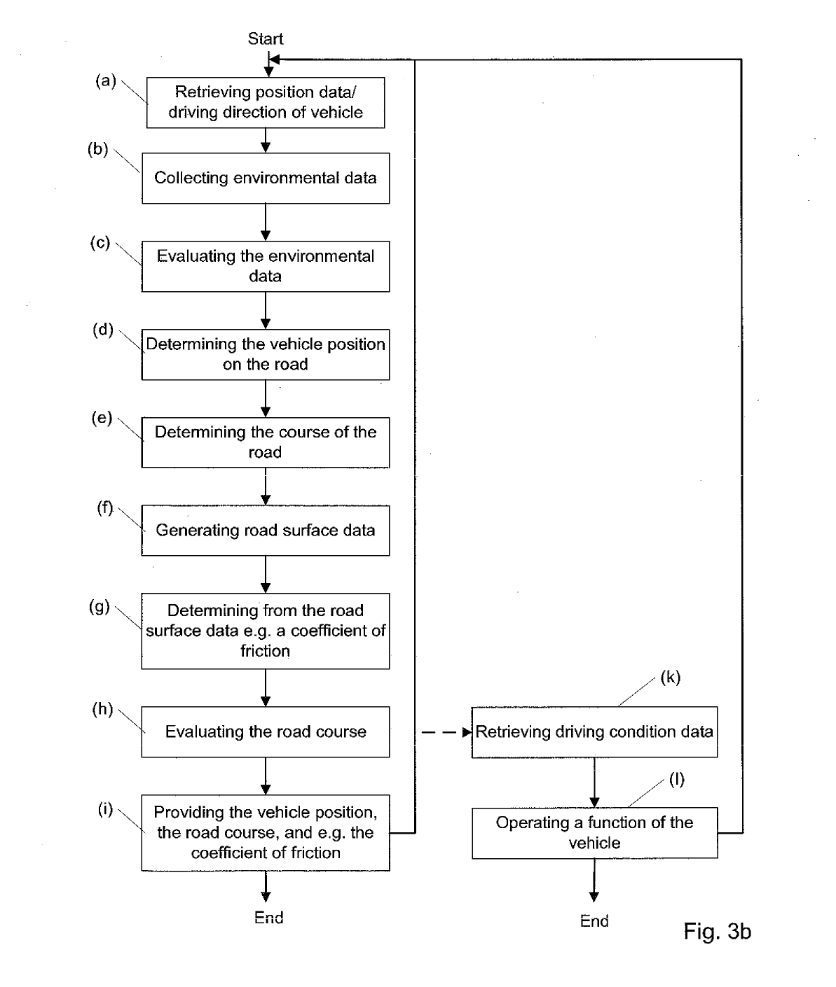

FIG. 3a shows a schematic flow diagram of a method according to an exemplary embodiment of the invention;

FIG. 3b shows a schematic flow diagram of a method according to an exemplary embodiment of the invention, wherein a road course and a vehicle position are taken into account;

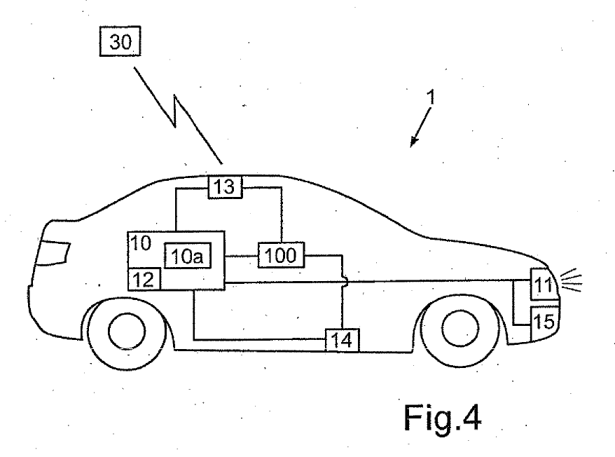

FIG. 4 shows in a schematic diagram a control device according to an exemplary embodiment of the invention;

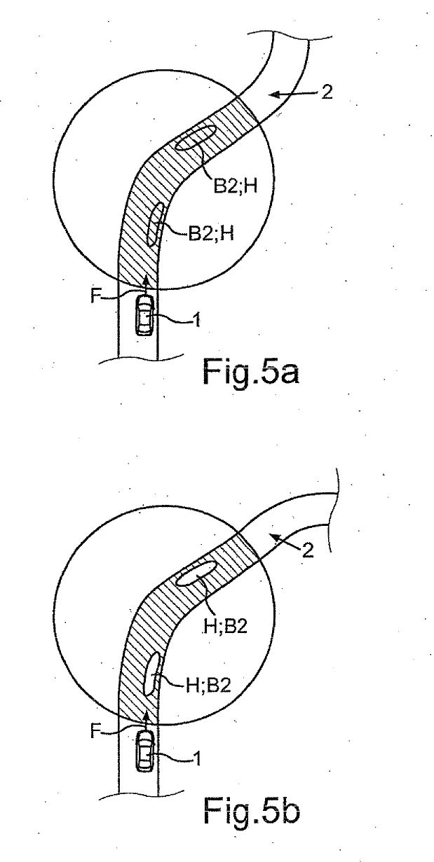

FIG. 5a shows in a top view a schematic diagram of a situation in a method, wherein all areas of a road are detected as a function of a road course; and

FIG. 5b shows in top view a schematic diagram of a situation in a method according to the invention, wherein only navigable areas of a road are detected as a function of a road course and non-navigable areas may be excluded.

FIG. 1 shows a vehicle 1 that uses a road 2. The road 2 has a road surface 2a with a location-dependent condition. The road 2 has two lanes 2.1 marked by road markings 2.3 and having a respective road surface 2.1a. The road surfaces 2.1a can be constructed from the same material, or from different materials, for example from two different grades of tar. The road 2 also includes a hard shoulder 2.2 and is delimited on both sides by a guard rail 3. Boundary posts 4 are provided adjacent to the hard shoulder 2.2.

The vehicle 1 approaches in a direction F a hazardous area B1 in the right lane 2.1. A non-navigable area B2, for example an area blocked by an obstacle H, is indicated on the hard shoulder 2.2. The vehicle 1 has a vehicle system 100 that is coupled to or includes a control device 10. The vehicle system 100 can be configured as or can include a driver assistance system. The control device 10 is configured to detect a course of the road 2 and to determine coefficients of friction of the road surface 2a as a function of the road course and as a function of non-navigable areas B2.

FIG. 2 illustrates a situation comparable to the situation shown in FIG. 1. In this case, an obstacle H is formed by a parked vehicle 1a. This causes a non-navigable area B2, which is in this case slightly larger than the area covered by the vehicle 1a. In other words, a driver assistance system must take into account that a certain distance from the parked vehicle 1a must be maintained at high speeds, even during an evasive maneuver in an emergency situation where the controlled vehicle 1 should or must be steered away from the lane 2.1. The vehicle 1 includes a vehicle system 100, which includes a control device 10. The vehicle system 100 may be configured as or may include a driver assistance system.

FIG. 3a shows in form of a schematic diagram that a method for predictive determination of a parameter value of a surface navigable by a vehicle and for providing the parameter value to at least one driver assistance system of the vehicle can already result in an improved database due to a very manageable number of process steps, in particular by

a first step 1), in which a total surface is detected on which the vehicle can travel,
a second step 2), in which a partial region that is actually navigable by the vehicle within the total surface is determined, and by
a third step 3), in which the parameter value is determined that is intended exclusively for the partial region. Optionally, the step 1) can be further improved by detecting the total surface from detected thermal radiation, in particular with a surroundings sensing device, and by extracting road surface data from a thermal image obtained from the thermal radiation by analyzing a temperature profile in the thermal image and by determining from the thermal image a change in the parameter value, in particular by using the surroundings sensing device or a control device separate from the surroundings sensing device.

FIG. 3b shows a schematic diagram of the manner in which a method according to the invention can be carried out according to an exemplary embodiment, wherein a road course and a vehicle position are taken into account, in particular when the exemplary embodiment is carried out in conjunction with a driver assistance system. The individual steps can be described in the following way and are part of a method for providing a parameter value characterizing a road surface in relation to a road course ahead and a geographic position and a driving direction of a vehicle using the road for at least one driver assistance system of the vehicle:

a) retrieving geographical real-time position data for the vehicle position of the vehicle and detecting the driving direction of the vehicle;
b) collecting environmental data in a predetermined environment around the vehicle position with a surroundings sensing unit;
c) evaluating the environmental data for recognizing road data at least of the used road in the environment, and associating the vehicle with the road by using a control device;
d) determining the vehicle position on the road by combining the road data with the position data using the control device;
e) determining the course of the road from the road data with respect to the driving direction;
f) detecting radiation reflected from the road surface, and generating road surface data;
g) determining from the road surface data the parameter values characterizing the road surface, in particular a coefficient of friction;
h) in conjunction with the parameter value;
i) evaluating the road course providing the vehicle position, the road course, and the parameter value, in particular the coefficient of friction;
whereby the individual steps have the following characteristic:

during the evaluation of the environmental data or road-surface data: determining non-navigable sections of the road, especially from the environmental data, by determining obstacles on the road that cannot be navigated by the vehicle, in particular by examining an area above the road surface for the presence of contours extending in a vertical orientation at an angle to the road surface;

during the determination or evaluation of the road course: excluding the non-navigable sections, especially from the environmental data, and analyzing the remaining navigable sections; and

in step i): providing the road course and the parameter value, in particular with respect to the location of the navigable sections, by combining the road surface data with the remaining, non-excluded environmental data.

This can improve the accuracy of the evaluation by effectively preventing a misinterpretation of parameter values, in particular in the evaluation of the parameter value based on the temperature of the road surface: heat radiated onto the road surface by parked vehicles does not result in data to be considered when controlling the vehicle, because this temperature change can be associated with the parked vehicle (obstacle) and excluded. Preferably, the parameter value is determined only for those areas of the road, where no obstacle is present, i.e. for areas of the road that are navigable and not excluded. The areas are preferably excluded before determining any parameter values, in particular coefficients of friction.

The determined course of the road or lane can be used for further steps of the process by taking into account the excluded non-navigable sections, in particular the steps of:

k) retrieving driving condition data for a driving condition of the vehicle; and
l) operating at least one function of the vehicle depending on the vehicle position, the road course, the parameter value and in dependence of the driving condition.

These steps can be taken over by a driver assistance system, which can be designed as a subsystem of the vehicle system.

FIG. 4 shows a control device 10 arranged in a vehicle 1 and having a processor 10a and memory means 12, which is coupled with a position detection device 13, a vehicle system 100, a radiation detection unit 11, a surroundings sensing device 15, and an actuator 14. The actuator 14 can be operated via the control device 10 and/or the vehicle system 100, in particular for setting the driving condition of the vehicle 1. The control device 10 and/or the vehicle system 100 are in communication with a data server 30 by way of a communication interface, from which data related to a course of the road or to certain features of the environment can be selectively transmitted.

FIG. 5a shows that in a method for detecting parameters of a road surface, a road course of the road 2 can be taken into account by detecting only the areas of the road itself, but not the surrounding area. A vehicle 1 using the road 2 detects in the driving direction F ahead of the vehicle 1 a defined area (circled area) and determines the road course and only takes into account the actual areas of road 2, according to the dotted area, i.e. not the environment. This area includes areas B2 where a non-navigable obstacle H is present.

FIG. 5b shows areas that may be considered in a method according to the invention and areas that may be excluded. The dotted area where a parameter characteristic of the road surface is evaluated is limited to the navigable areas of the road 2. In other words, non-navigable areas B2, in which for example an obstruction H may be arranged, may be excluded, especially before an in particular location-based evaluation of the parameter is performed.

What is claimed is:

1.-7. (canceled)

8. A method for predictive determination of a parameter value of a surface on which a vehicle can drive, comprising:
detecting a total surface that is provided for the vehicle to drive on,
determining a partial region within the total surface, on which the vehicle can actually drive,
determining the parameter value only for the partial region, and
providing the parameter value to at least one driver assistance system of the vehicle.

9. The method of claim 8, wherein the partial region is determined by identifying an obstacle on the total surface that is insurmountable by the vehicle.

10. The method of claim 8, wherein the total surface is detected by evaluating radiation incident on the vehicle.

11. The method of claim 8, wherein the parameter value comprises a coefficient of friction characteristic of friction between a tire of the vehicle and a surface in the partial region.

12. The method of claim 8, wherein the total surface is detected by detecting thermal radiation, the method further comprising:
extracting road-surface data characterizing the parameter value from a thermal image obtained from the thermal radiation,
analyzing a temperature profile in the thermal image, and
determining from the thermal image a change in the parameter value.

13. The method of claim 12, wherein the thermal radiation is detected with a surroundings sensing unit.

14. The method of claim 12, wherein the change in the parameter value is determined with the surroundings sensing unit or with a control device that is separate from the surroundings sensing unit.

15. The method of claim 8, further comprising
evaluating the partial region and the parameter value with a control device or with a vehicle system coupled to the control device, and
checking whether a function of the vehicle must be controlled.

16. A control device for predictive determination of a parameter value of a surface on which a vehicle can drive, wherein the control device is configured to
evaluate surface data of a total surface that is provided for the vehicle to drive on,
determine a partial region within the total surface, on which the vehicle can actually drive,
determine the parameter value only for the partial region, and
provide the parameter value to at least one driver assistance system of the vehicle.
